(19) United States
(12) Patent Application Publication
(10) Pub. No.: US 2008/0130601 A1
(43) Pub. Date: Jun. 5, 2008

(54) METHOD FOR PROVIDING NETWORK COMMUNICATION SERVICE WITH CONSTANT QUALITY REGARDLESS OF BEING IN WIRED OR WIRELESS NETWORK ENVIRONMENT

(75) Inventors: Sun-Me Kim, Daejeon-city (KR); Kyoung-Soon Kang, Daejeon-city (KR); Hae-Sook Kim, Daejeon-city (KR); Jong-Rak Kim, Daeieon-city (KR); Jeong-Jong Lee, Daejeon-city (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institute, Daejeon-city (KR)

(21) Appl. No.: 11/933,010

(22) Filed: Oct. 31, 2007

(30) Foreign Application Priority Data
Dec. 1, 2006 (KR) 10-2006-0120981
Jul. 11, 2007 (KR) 10-2007-0069803

(51) Int. Cl. H04L 12/28; H04L 12/56; H04L 29/06

(52) U.S. Cl. 370/338

(57) ABSTRACT

A method of allowing a network communication service user (subscriber) to receive a desired network communication service with a constant (the same) quality regardless of being in a wired or wireless communication environment based on a single service level agreement (SLA) of the subscriber is provided. The method of providing the network communication service with the constant quality regardless of the wired or wireless network environment includes: (a) setting a call control policy for a service so that an SLA (service level agreement) of a network communication service user is available for the wired or wireless network; (b) determining whether the user accesses the network through the wired or wireless network; (c) determining whether the user is a wired network home user or a wired network guest user when the user accesses the network through the wired network; and (d) providing a network communication service requested by the user based on the call control policy based on the determination result of (b) and (c) for the user.

### CROSS-REFERENCE TO RELATED PATENT APPLICATION

This application claims the benefit of Korean Patent Application No. 10-2006-0120981, filed on Dec. 1, 2006 and Korean Patent Application No 10-2007-0069803, filed on Jul. 11, 2007 in the Korean Intellectual Property Office, the disclosures of which are incorporated herein in their entirety by reference.

### BACKGROUND OF THE INVENTION

1. Field of the Invention

The present invention relates to a method of providing a network communication service with constant quality, and more particularly, to a method of providing a desired network communication service with constant quality regardless of being in a wired or wireless network environment based on a single service level agreement (SLA) to a user (subscriber). The user is referred to as a nomadic subscriber. The single SLA indicates an SLA which is available for the same user regardless of being in a wired or wireless network.

2. Description of the Related Art

The amount of usage of network communication services through an Internet protocol (IP) packet network has drastically increased. Specifically, demands for a multimedia IP communication service such as a voice-over-Internet protocol (VoIP), multimedia over Internet protocol (MMoIP), a video on demand (VoD), an Internet protocol television (IPTV), and the like have increased. The quality of the multimedia IP communication service through the IP packet network is required to be the same as that through a circuit network.

In addition, a user expects to receive a multimedia IP communication service (hereinafter, referred to as ‘IP communication service’) and an IP data communication service (hereinafter, referred to as ‘IP data service’) with constant quality regardless of being in a wired or wireless environment while freely moving between a wired network and a wireless network in addition to being in a wired network of a fixed location.

At present, research is being carried out on procedures of authenticating a nomadic subscriber and providing a service to the nomadic subscriber in the wired network. However, most providers provide a multimedia IP communication service and an IP data communication service in which a technique for controlling users and services has independent management capability and service providing capability for a user who registered through a wired or wireless network for each provider. Accordingly, when there is a difference in quality of service between a service which can be provided in a home, that is, a service provided through a wired network and a service provided through an external public wireless network, separate SLAs are needed for the same user in the wired network and wireless network. In addition, accounts are separately managed, and billing services are separately performed.

This is disadvantageous in development of a method of providing a desired network communication service with constant quality at any time and at any place.

### SUMMARY OF THE INVENTION

The present invention provides a method of providing a network communication service with constant quality regardless of being in a wired or wireless network environment, suitably to a service level of a subscriber (a single service level agreement (SLA)) by setting and applying a call control policy so that a single SLA is available for a nomadic subscriber in a wired or wireless network environment.

According an aspect of the present invention, there is provided a method of providing a network communication service with constant quality regardless of being in a wired or wireless environment, the method comprising: (a) setting a call control policy for a service so that an SLA (service level agreement) of a network communication service user is available for the wired or wireless network; (b) determining whether the user accesses the network through a wired or a wireless network; (c) determining whether the user is a wired network home user or a wired network guest user when the user accesses the network through the wired network; and (d) providing a network communication service requested by the user based on the call control policy based on the determination result of (b) and (c) for the user.

In the present invention, it is assumed that in the case of the wired network, there are fixed subscribers (home subscribers) and that the wireless network indicates public network resources which do not belong to a specific subscriber so as to allow a provider to expand a service area. That is, the wireless network is shared resources. In the case of the wired network, priorities are given to the home users.

In the starting concept of the present invention, it is possible to secure the quality of service which is provided to the user, when the SLA for the same user is the same in the wired and wireless network.

Accordingly, the present invention provides a control method capable of providing an IP communication service or IP data service with constant quality in wired and wireless networks by allowing the same SLA to be available in the wired and wireless networks for a nomadic subscriber regardless of whether the subscriber is located in the wired or wireless network.

For this, in the present invention, in a wired network, it is possible to receive a desired service without an influence of a service for another subscriber. In a wireless network, it is possible to receive a network communication service by dynamically receiving a band suitably to a service level of the user.

Accordingly, it is possible to effectively control a service by applying a consistent service providing principle to a network communication service including an IP communication service with high quality and a best effort IP data service by using limited resources of a network.

That is, according to an embodiment of the present invention, it is possible for a communication provider to effectively expand a service area served by the wired network and a service area served by the wireless network at the same time by providing a method of controlling a call and providing a service for a multimedia IP communication service and a IP data communication service so that the same SLA is available in the wired network and the wireless network. It is possible for the user to receive a service with constant quality suitably to a service level that is registered by the user.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a network environment in which the present invention is embodied;

FIG. 2 illustrates a detailed example in which a wired network home user receives an IP communication service according to an embodiment of the present invention;

FIG. 3 illustrates a detailed example in which a wired network guest user receives an IP communication service according to an embodiment of the present invention;

FIG. 4 illustrates a detailed example in which a wired network home/guest user receives an IP data service according to an embodiment of the present invention;

FIG. 5 illustrates a detailed example in which a wired network guest user receives an IP communication service according to an embodiment of the present invention;

FIG. 6 illustrates a detailed example in which a wireless network guest user receives an IP data service according to an embodiment of the present invention; and

FIGS. 7A to 7D illustrate exemplary embodiments of the present invention.

### DETAILED DESCRIPTION OF THE INVENTION

The attached drawings for illustrating exemplary embodiments of the present invention are referred to in order to gain a sufficient understanding of the present invention, the merits thereof, and the objectives accomplished by the implementation of the present invention.

Hereinafter, the present invention will be described in detail by explaining exemplary embodiments of the invention with reference to the attached drawings. Like reference numerals in the drawings denote like elements.

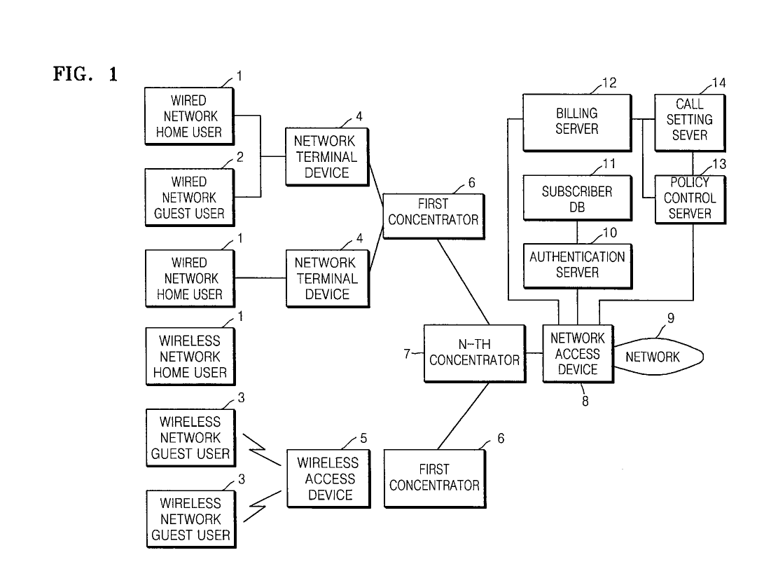

FIG. 1 illustrates a network environment in which the present invention is embodied.

A wired network home user 1 indicates a subscriber to whom a network access line is allocated and who accesses a network from the home of the user. A wired network guest user 2 indicates a subscriber who accesses the network through an access line of another subscriber who receives the access line, that is, an access line of the wired network home user 1. A wireless guest user 3 indicates a user who accesses the network from a public wireless network such as a cafe or school. As described above, since the wireless network is a public resource, a user who accesses the network from the wireless network is always a guest user.

A wired network accesses the network through a network terminal device 4. A wireless network accesses the network through a wireless access device 5 such as an access point. Subscriber traffic is concentrated through one or more first concentrators 6 and 7. The concentrated traffic is once more concentrated through an N-th concentrator 7 and transmitted to a network access device 8.

The subscriber traffic is processed by the network access device 8 through a function of identifying a subscriber, a routing function, and a function of providing an additional service and is routed to the network, so that the requested service is transmitted from the user.

There are a plurality of managers for managing traffic and services in a control layer. An authentication server 10 for authenticating a subscriber serves to authenticate a subscriber, to manage a service profile, and to give an authority through communication and sharing of information with a subscriber information management server/DB 11. In addition, a billing server 12 for billing a service requested by the user performs a billing function by receiving data for billing the service from the network access device 8 and the call setting server 14.

An IP communication service requested by the subscriber indicates a service that goes through a procedure of controlling an acceptance of a call. The IP communication service is provided after the call is set through signaling between the call setting server 14 and a terminal. In order to examine availability of network resources and allocate resources in the procedure of setting a call, the call setting server 14 controls setting of a call so that desired quality of service is provided through linkage with the policy control server 13.

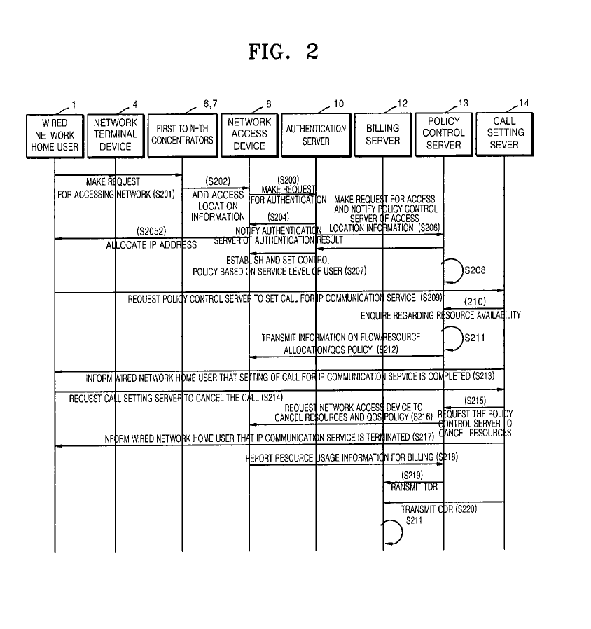

FIG. 2 illustrates a detailed example in which a wired network home user receives an IP communication service according to an embodiment of the present invention.

When the wired network home user 1 makes a request for accessing the network so as to receive the IP communication service (operation S201), the concentrators 6 and 7 add information on a path (information on a location) that is accessed by the user 1 to an access request signal packet and transmits the access request signal packet to the network access device 8 (operation S202).

The network access device 8 requests the authentication server 10 to authenticate the access request user 1 (operation S203). The authentication server 10 responds to an authentication request by notifying the network access device 8 of the authentication result (operation S204). The network access device 8 allocates an IP address that is to be used to receive the IP communication service to the authenticated user 1 (operation S205). The authentication server 10 transmits a service profile including an access request and information on an access location from the user 1 to the policy control server 13 (operation S206).

The policy control server 13 establishes a call control policy suitable to a service level of the user based on the transmitted service profile and transmits the call control policy to the network access device 8 via the authentication server 10 to allow the call control policy to be set in the network access device 8 based on the service level of the access request user (operation S207).

The policy control server 13 determines whether the user 1 is a wired network user or wireless network user. When the user 1 is determined as the wired network user, it is determined whether the user 1 is a wired network home user or wired network guest user (operation S208). In the case of FIG. 2, the user 1 is assumed to be a wired network home user.

Next, when the user requests the call setting server 14 to set a call for an IP communication service so as to request the call setting server 14 to provide the IP communication service (operation S209), the call setting server 14 asks the policy control server 13 about availability of resources so as to determine whether the network resource is valid (operation S210). The policy control server 13 examines whether the resources are available based on information of resources managed by the policy control server 13 (operation S211). When the resources are available, the policy control server 13 transmits resource allocation information and a quality of service (QoS) policy that is to be controlled, in addition to flow information for the corresponding IP communication service (operation S212). On the other hand, the call setting server 14 informs the user 1 that it is possible to use the IP communication service since the call for the IP communication service is set (operation S213).

When the user 1 requests the call setting server 14 to cancel the service while receiving the IP communication service (operation S214), the call setting server 14 requests the policy control server 13 to cancel the allocated network resource (operation S215), and the policy control server 13 terminates the service by making a request for canceling the resource allocated to the network access device 8 and canceling the setting of the QoS control policy (operation S216). The call setting server 14 informs the user 1 that the IP communication service is terminated (operation S217).

After the IP communication service is completed, the network access device 8 reports information on a usage amount of network resources used for billing to the policy control server 13 (operation S218). The policy control server 10 and the call setting server 14 enables a billing operation to be performed (operation S221) by respectively transmitting a traffic detail record (TDR) and a call detail record (CDR) to the billing server 12 (operations S219 and S220)

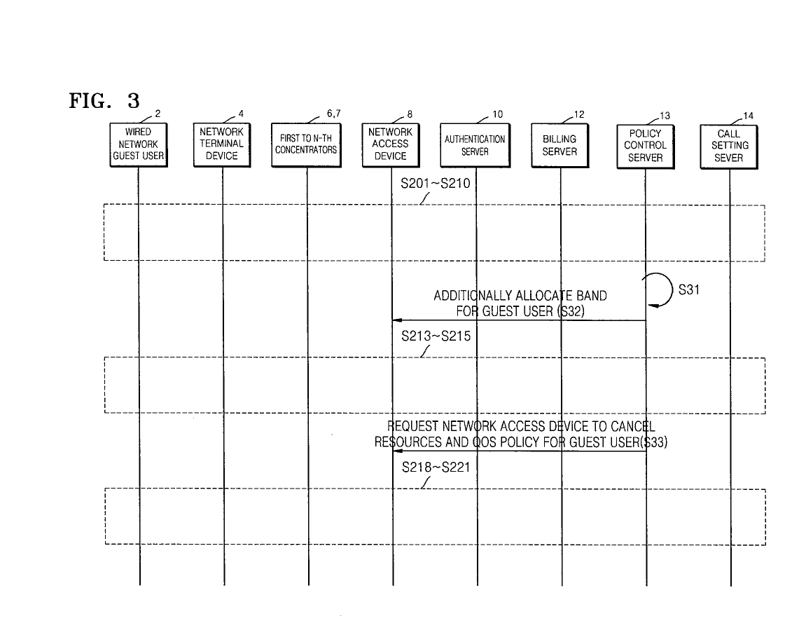

FIG. 3 illustrates a detailed example in which a wired network guest user receives an IP communication service according to an embodiment of the present invention.

As shown in FIG. 3, procedures in which the wired network guest user 2 receives the IP communication service are almost the same as the procedures in which the wired network home user shown in FIG. 2 receives the IP communication service. However, since the wired network guest user 2 accesses the network through the access line of the wired network home user 1, when the wired network guest user 2 desires to use the IP communication service, the wired network guest user 2 has to consider an influence on the wired network home user 1.

For this, the policy control server 13 determines the type of an accessed subscriber (operation S208). When the accessed subscriber is determined as the wired network guest user 2, it is determined whether a band except a band that is reserved to be allocated to the wired network home user can include a necessary band of the IP communication service requested by the guest user 2 (i.e. whether the wired network guest user 2 influences the wired network home user) (operation S31). When the band except the reserved band can include the necessary band, the policy control server 13 requests the network access device 8 to additionally allocate a band for the guest user 2, allocate resources, and dynamically set the QoS policy (operation S32).

When the guest user 2 terminates the IP communication service, the resource allocated for the IP communication service of the guest subscriber which is additionally set is cancelled (operation S33). The billing processes (operation S218 to S221) are performed.

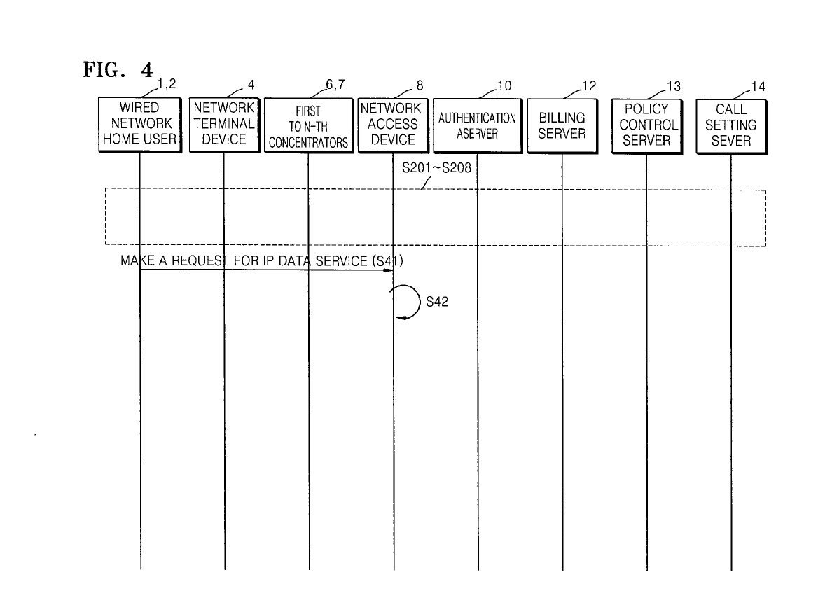

FIG. 4 illustrates a detailed example in which a wired network home/guest user receives an IP data service according to an embodiment of the present invention.

Procedures of authenticating a user so as to provide the IP data service are the same as the procedures of providing the IP communication service to the wired network user shown in FIGS. 2 and 3 (operations S201 to S208). When the wired network home/guest user 1 or 2 makes a request for the IP data service (operation S41), the QoS policy which is determined based on the service level policy of the user service profile that is set in the network access device 8 and a packet for the IP data service are forwarded from the user 1 or 2 to the network 9 based on priorities (operation S42).

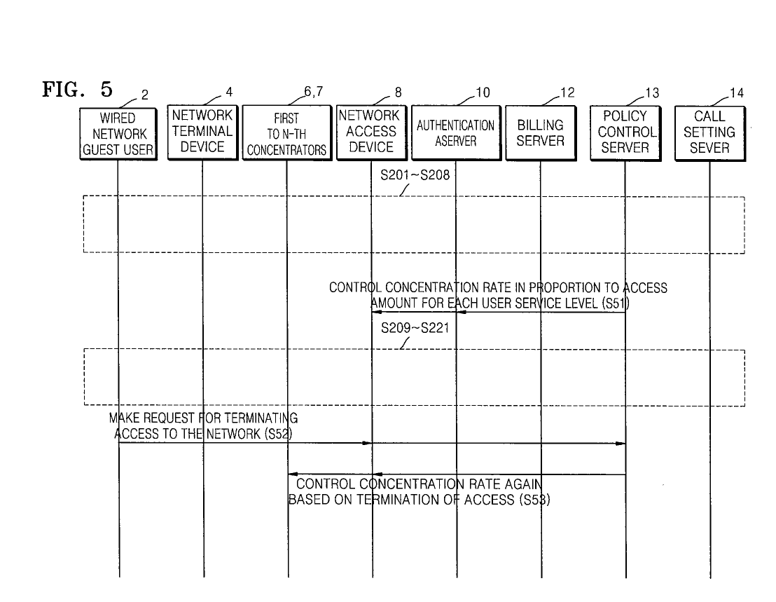

FIG. 5 illustrates a detailed example in which a wired network guest user receives an IP communication service according to an embodiment of the present invention.

Procedures of authenticating a user for the IP communication service through a wireless network are the same as the procedures of authenticating the wired network user (operations S201 to S207). The policy control server 13 determines that the user is the wireless network guest user 3 (operation S208), a concentration rate for each user service level that is set in the concentrators 6 and 7 and the network access device 8 is controlled (operation S51) by dynamically controlling the concentration rate that includes the allocated band of the service level of the corresponding user and a processing rate in proportion to an access amount for each user service level. Accordingly, this allows the user to have an opportunity of using the network resource suitable for the service level of the user even in the state where the network is congested.

Here, methods of controlling the concentration rate may be various according to providers. For example, there is a policy for providing a service by classifying user service levels of a communication network provider into premium, gold, silver, and best effort. The concentration rate is controlled so that 20% of the entire band is allocated to only the premium users when the number of users with the premium level who access the wireless network is equal to or less than 20 and so that 40% of the entire band is allocated only to the premium users when the number of users with the premium level who access the wireless network ranges from 20 to 50. In the other levels, the concentration rate is controlled similarly.

A method of processing a call for the IP communication service through the wireless network is the same as that in the case where the IP communication service is provided to the wired network home subscriber (operations S209 to S221). When the wireless network guest user 3 makes a request for terminating access to the network (operation S52), the policy control server 13 again controls the concentration rate for each user service level (operation S53).

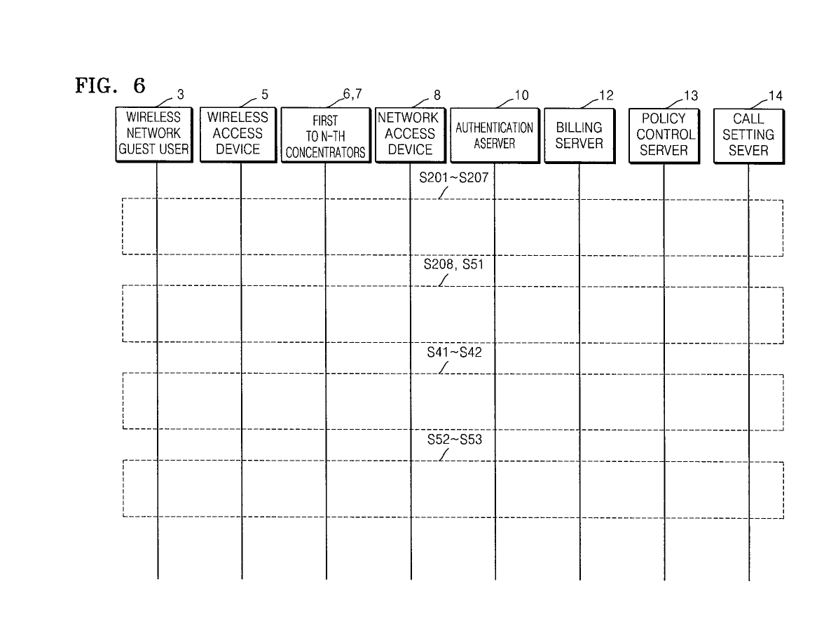

FIG. 6 illustrates a detailed example in which a wireless network guest user receives an IP data service according to an embodiment of the present invention.

The procedures of authenticating a user (operations S201 to S207) and the procedures of controlling a concentration rate in response to the request for accessing the network of the wireless network guest user 3 are the same as those in the case of the IP communication service of the wireless network guest user. When the wireless network guest user 3 makes a request for the IP data service (operation S41), a packet for the IP data service is forwarded based on the QoS policy and the priority which are set based on the service level policy of the registered service profile of the user that are set in the network access device 8 by the authentication server 10 (operation S42). When the wireless network guest user 3 makes a request for terminating the access to the network (operation S52), the policy control server 13 again controls the concentration rate for each user service level (operation S53).

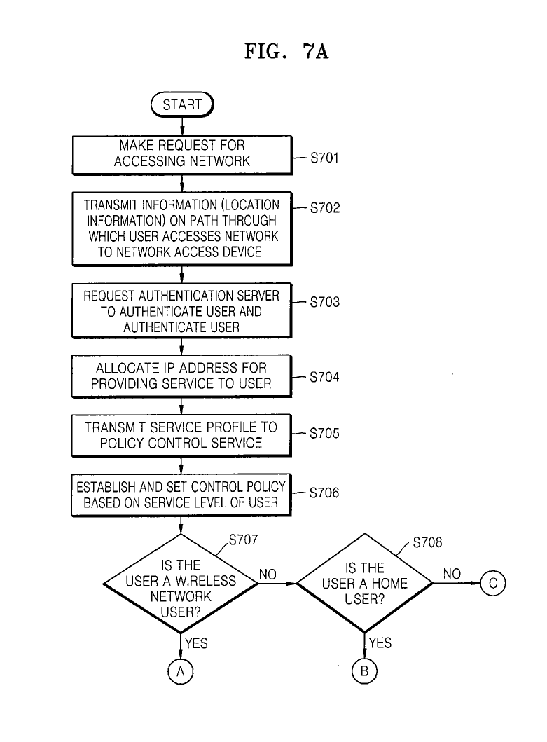

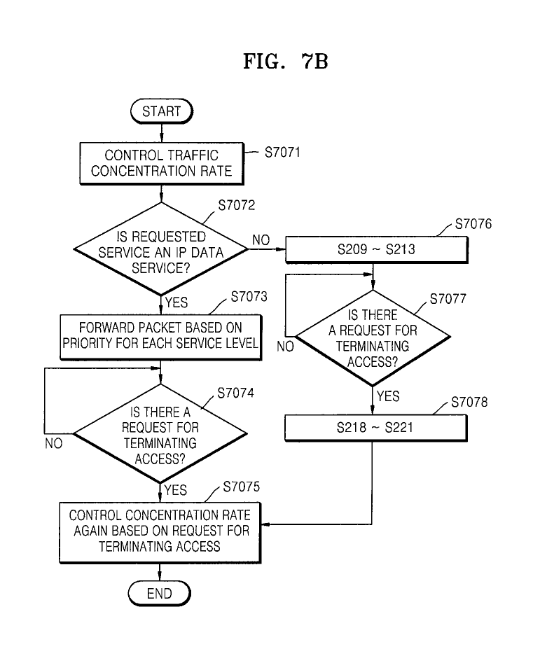

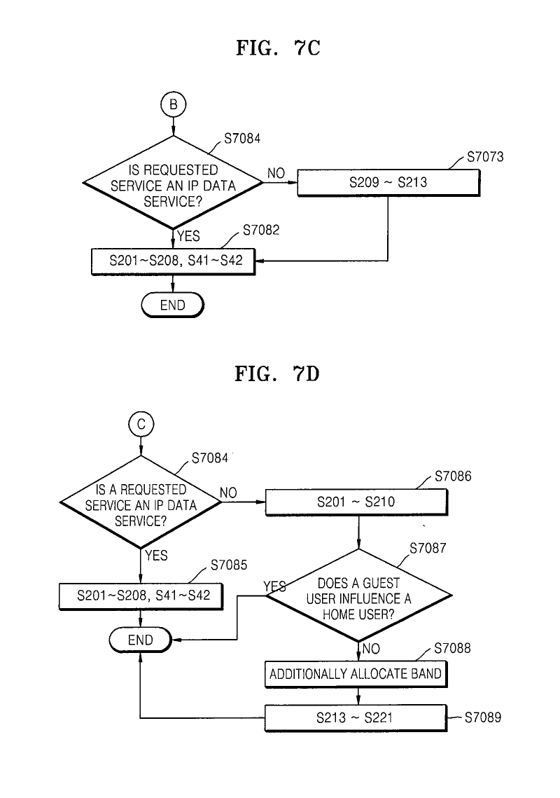

FIGS. 7A to 7D illustrate procedures employed when a nomadic user desires to receive the IP communication service or IP data service based on a service level agreement (SLA) of the nomadic user by accessing the network through the wired network or wireless network according to exemplary embodiments of the present invention. That is, the procedures shown in FIGS. 7A to 7D include the procedures shown in FIGS. 2 to 6.

When the user makes a request for accessing the network (operation S701), the concentrators 6 and 7, which transmit an access request signal packet, add information (location information) on the path through which the user accesses the network to the access request signal packet and transmit the access request signal packet to the network concentration device 8 (operation S702).

The network concentration device 8 requests the authentication server 10 to authenticate the access request user, and the authentication server 10 authenticates the access request user by notifying the network concentration device 8 of the authentication result (operation S703). The network concentration device 8 allocates an IP address for receiving the IP communication service or IP data service to the authenticated user (operation S704).

On the other hand, the authentication server 10 transmits a service profile including the access request and the access location information from the user to the policy control server 13 (operation S705). The policy control server 13 establishes a control policy suitable to the service level of the access request user, that is, the SLA of the user based on the received service profile, transmits the control policy to the network access device 8 via the authentication server 10, and allows the control policy to be set in the network concentration device 8 based on the service level of the access request user (operation S706).

The policy control server 13 determines whether the access request user accesses the network through the wired network or wireless network (operation S707). When the access request user accesses the network through the wired network, the policy control server 13 determines whether the user is a home user or guest user (operation S708).

Then, the IP communication service or IP data service is performed based on the control policy that is set based on the access type of the access request user and the requested service.

A) Case where the Access Type of the Access Request User is the Wireless Network Guest User 3

In order to secure the quality of the service of the wireless network guest user 3 from the traffic congestion which may occur due to an increase of the number of users who access the network based on the service levels, the policy control server 13 enables the quality of the service to be secured by dynamically controlling the wireless access device 5 for a service level of each user and a traffic concentration rate of the concentrators 6 and 7 based on the number of the users (operation S7071).

Next, the policy control server 13 determines whether the service requested by the wireless network guest user 3 is the IP data service (operation S7072). When the requested service is the IP data service, a packet is forwarded according to the service control policy based on the priorities for each predetermined user service level (operation S7073), and the IP data service is performed. The policy control server 13 determines whether the wireless network guest user 3 makes a request for terminating the access to the network while performing the IP data service for the wireless network guest user 3 (operation S7074). When the wireless network guest user 3 makes a request for terminating the access to the network, the policy control server 13 terminates providing of the IP data service for the wireless network guest user 3 by again controlling the concentration rate for each user service level (operation S7075).

On the other hand, when the service requested by the wireless network guest user 3 is the IP communication service, after the traffic concentration rate is controlled by the policy control server 13 (operation S7071), the IP communication service is performed through operations S209 to S213 of FIG. 2 (operation S7076).

The policy control server 13 determines whether the wireless network guest user 3 makes a request for terminating the access to the network while performing the IP communication service for the wireless network guest user 3 (operation S7077). When the wireless network guest user 3 makes a request for terminating the access to the network, a billing process is performed through operations S218 to S221 (operation S7078). The policy control server 13 terminates providing of the IP communication service for the wireless network guest user by again controlling the concentration rate for each user service level (operation S7075).

B) Case where the Access Type of the Access Request User is the Wired Network Home User

When the access request user is the wired network home user 1, it is determined whether the requested service is the IP data service (operation S7081). When the requested service is the IP data service, the IP data service is performed through the procedure shown in FIG. 4 (operation S7082). As a result of determination in operation S7081, when the requested service of the wired network home user is the IP communication service, the IP data service is performed through the procedures shown in FIG. 2 (operation S7083).

C) Case where the Access Type of the Access Request User is the Wired Network Guest User

When the access request user is the wired network guest user 2, it is determined whether the requested service is the IP data service similarly to the case of the wired network home user 1 (operation S7084). When the requested service is the IP data service, the IP data service is performed through the procedure shown in FIG. 4.

As a result of determination in operation S7084, when the requested service of the wired network guest user 2 is the IP communication service, operations S201 to S210 of FIG. 2 are performed similarly to the case of the IP communication service of the wired network home user 1 (operation S7086). However, as described above, since the wired network guest user 2 is a subscriber who accesses the network through the access line of the wired network home user 1, when the wired network guest user 2 uses the IP communication service, it has to be determined whether the wired network guest user influences the wired network home user (operation S7087).

For this, the policy control server 13 checks whether a band except a band reserved to be allocated to the wired network home user 1 can include a necessary band of the IP communication service requested by the guest user 2 (i.e. whether the wired network guest user 2 influences the wired network home user). When the band except the reserved band can include the necessary band, the policy control server 13 enables the IP communication service to be performed, after enabling the network access device 8 to additionally allocate a band for the guest user 2, allocate resources, and dynamically set the QoS policy (operation S7089).

Information that has to be established so as to embody the present invention is represented in the following Tables.

The authentication server 10 includes information on a subscriber identifier (ID), a password, and a subscriber service profile as basic information for authenticating the subscriber and authorizing the subscriber to access the network. In addition, information on a location of a home network of the subscriber includes identification information for identifying information on a path through which the subscriber accesses the network from the home, the identification information including a network-attached storage Internet protocol (NAS IP) address, a port number of a concentrator, a virtual local area network identifier (VLAN ID), a virtual path identifier/virtual channel identifier (VPI/VCI), and the like and service level information of the subscriber corresponding to the SLA of the subscriber, the service level information obtained by classifying service levels into premium, gold, silver, and bronze subscribers and differentiating price policies to grade types of the service, service qualities, and bands.

| Name | Contents |
|---|---|
| Subscriber ID | ID for identifying a subscriber |
| Information for | Information such as ID, Password, etc |
| authenticating subscriber | |
| Location of home network | Location of subscribed wired network of |
| of subscriber | subscriber (NAS, connection device port, |
| | VLAN, virtual path/virtual channel |
| | (VP/VC)) |
| Service level of subscriber | Service priority (for example, premium, |
| | gold, silver, bronze, and etc.) |
| Information on subscriber | Information on service registered by |
| service profile | subscriber |

The policy control server 13 includes information on network resource configuration, state information, policy information such as QoS, network address port translation (NAPT), and the like for controlling a policy, and information on equipment of the wireless network for determining information on an access location of the wireless network, when a nomadic user accesses the network through the wireless network.

| Name | Contents |
|---|---|
| Network resource | Information configuration, band, and state |
| configuration and state | for checking availability of network |
| information | resources |
| Information on wireless | Information on equipment of public wireless |
| network equipment | network |
| Information for controlling | Policy information such as QoS, NAPT, and |
| a policy | the like for managing the network |

The network access device 8 and the concentrators 6 and 7 include other setting information for operating a system, queue management information for controlling an upstream traffic that is transmitted from the subscriber to the network, and queue management information for controlling a downstream traffic. The queue management information for controlling the upstream traffic includes information on queue management, band management for each queue, and QoS processing as much as the number of service levels to be provided by a provider. The queue management information for controlling the downstream traffic includes information on queue management, band management for each queue, and QoS processing for a plurality of subscribers for each port. In addition, other information includes information on queue management, band management for each queue, and QoS processing for each subscriber.

| Name | Contents |
|---|---|
| Queue for controlling | Queue management, band management, and QoS |
| upstream traffic | processing appropriate for the number of service |
| | levels for each port |
| Queue for controlling | queue management, band management, and QoS |
| downstream traffic | process for a plurality of subscribers for each port |
| | a hierarchical queue processing function capable |
| | of managing a plurality of flow queues, managing |
| | a band, and processing QoS for each subscriber |
| | queue |
| Other system setting | Other setting information for operating a system |
| information | |

The method according to an embodiment of the present invention can also be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims.

The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of providing a network communication service with constant quality regardless of being in a wired or wireless environment, the method comprising:
(a) setting a call control policy for a service so that an SLA (service level agreement) of a network communication service user is available for the wired or wireless network;
(b) determining whether the user accesses the network through a wired or a wireless network;
(c) determining whether the user is a wired network home user or a wired network guest user, when the user accesses the network through the wired network; and
(d) providing a network communication service requested by the user according to the call control policy based on the determination result of (b) and (c) with respect to the user.

2. The method of claim 1, wherein the call control policy for the wired network guest user is set so that the service is provided only when a band except a band reserved to be allocated to the wired home user can include a necessary band of a service requested by the wired network guest user so as to secure the quality of the requested service based on the SLA of the wired network guest user.

3. The method of claim 1, wherein the call control policy for the user who accesses the network through the wireless network is set so that a traffic concentration rate is controlled based on the number of users who access through the wireless network so as to secure the quality of the requested service based on the SLA of the user who accesses through the wireless network from a confusion of wireless network, generated due to the user who accesses through the wireless network.
